(19) United States
(12) Patent Application Publication
(10) Pub. No.: US 2006/0166682 A1
(43) Pub. Date: Jul. 27, 2006

(54) Cell phone relative position indication on displayed map using GPS coordinates

(76) Inventors: Jeyhan Karaoguz, Irvine, CA (US); James D. Bennett, San Clemente, CA (US)

Correspondence Address: GARLICK HARRISON & MARKISON LLP, P.O. BOX 160727, AUSTIN, TX, 78716-0727, US

(21) Appl. No.: 11/069,445

(22) Filed: Mar. 1, 2005

Related U.S. Application Data
(60) Provisional application No. 60/647,256, filed on Jan. 26, 2005.

(51) Int. Cl. H04Q 7/20

(52) U.S. Cl. 455/456.2; 455/456.1

(57) ABSTRACT

A wireless terminal tracks a tracked wireless terminal and displays tracking information to a user. The tracking wireless terminal sends a tracking request for the tracked wireless terminal via a supporting wireless network infrastructure. When the tracking request is valid, the tracking wireless terminal receives a tracking response for the tracked wireless terminal. Based upon the tracking response, the tracking wireless terminal accesses a map segment corresponding to received location coordinates. The tracking wireless terminal determines a relative position of the location coordinates of the tracked wireless terminal with respect to the map segment. With this determination made, operation concludes with the tracking wireless terminal displaying the map segment and an icon on the map segment that represents the tracked wireless terminal. The icon representing the tracked wireless terminal is displayed at the relative position of the location coordinates of the tracked wireless terminal.

### CROSS REFERENCE TO RELATED APPLICATION

This application claims priority to U.S. Provisional Patent Application Ser. No. 60/647,256, filed Jan. 26, 2005, which is incorporated herein by reference for all purposes.

### BACKGROUND

1. Field of the Invention

The present invention relates generally to wireless communications; and more particularly to operations relating to the location/mobility of a wireless terminal.

2. Background of the Invention

Communication systems are well known. Communication systems include both wired communication systems and wireless communication systems. Wired communication systems include the Public Switched Telephone Network (PSTN), Wide Area Networks (WANs), Local Area Networks (LANs), and other networks that use wired or optical media for the transmission of data. Wireless communication systems include cellular telephone systems, satellite communication systems, Wireless Local Area Networks (WLANs), Wireless Personal Area Networks (WPANs), and other networks that employ a wireless link between a serviced terminal and a network infrastructure. Of course, many communications are serviced using a combination of wireless communication systems and wired communication systems.

With the current state of society, security of the person is of increasing importance. For example, parents who have children in daycare are particularly concerned for their safety. Likewise, the safety of adults as well is also a concern. Because many people typically carry cellular telephones and/or other wireless terminals, it would be appropriate to use such cellular telephones/wireless terminals to address such security concerns and location concerns. With the increasing reduction in size of wireless terminals, the use of such wireless terminals for security and location purposes becomes even more attractive. Thus, there is a need in the art for techniques for utilizing wireless terminals to address security concerns.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a system diagram illustrating a wireless communication system that operates according to the present invention;

FIG. 2A is a flow chart illustrating a first embodiment of operation according to the present invention;

FIG. 2B is a flow chart illustrating a second embodiment of operation according to the present invention;

FIG. 3A is a partial flow chart illustrating a first optional aspect of the present invention that may be used in conjunction with the operations of FIG. 2B;

FIG. 3B is a partial flow chart illustrating an optional second aspect of the present invention that may be used with either/both of the operations of FIGS. 2A and 2B;

FIG. 4 is a partial flow diagram illustrating a third optional aspect of the present invention;

FIG. 5 is a partial flow diagram illustrating a fifth optional aspect of the present invention;

FIG. 6A is a block diagram representing a display of a wireless terminal operating according to the present invention;

FIG. 6B is a block diagram representing a display of a wireless terminal operating according to the present invention and when in a compass mode;

FIG. 7 is a block diagram representing a display operating according to another embodiment of the present invention;

FIG. 8 is a flow diagram illustrating operation according to the present invention in servicing a tracking request;

FIG. 9 is a block diagram illustrating a wireless terminal constructed according to the present invention; and

FIG. 10 is a system diagram illustrating a system that may be used according to the present invention.

### DETAILED DESCRIPTION OF THE INVENTION

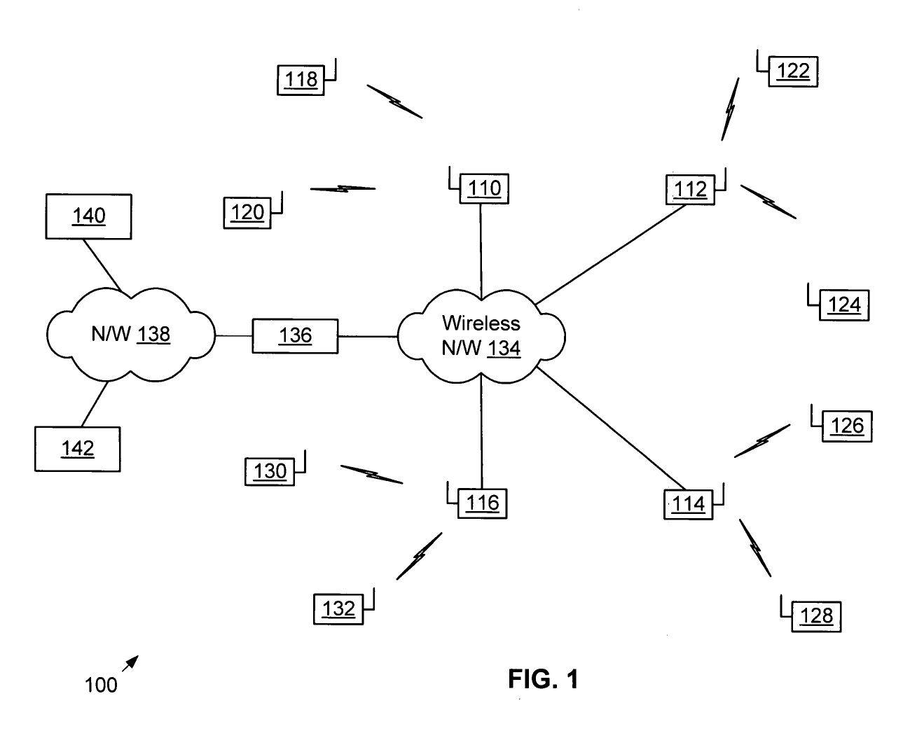

FIG. 1 is a system diagram illustrating a wireless communication system that operates according to the present invention. The wireless communication system 100 of FIG. 1 includes one or more servicing base stations and/or wireless access points (WAPs) 110, 112, 114, and 116. The reader should understand that the structure of FIG. 1 is used only to convey the principles of the present invention and is not intended to be a detailed description of a cellular wireless communication system, a Wireless Local Area Network (WLAN), a Wireless Wide Area Network (WWAN), or a Wireless Personal Area Network (WPAN).

As is shown, base station/WAP 110 supports wireless terminals 118 and 120 within a respective serving area, e.g., cell, sector, premises, area, etc. Likewise, base station/WAP 112 supports wireless terminals 122 and 124, base station/WAP 114 supports wireless terminals 126 and 128, and base station/WAP 116 supports wireless terminal 130 and 132. The base stations/WAPs 110, 112, 114, and 116 are serviced via network backbone 134 and interface device 136. The interface device 136 couples the backbone network 134 to another network 138. The another network 138 may include a Local Area Network (LAN), a Wide Area Network (WAN), the Internet, or any other type of network that couples the network backbone 134 via the network interface 136 to computers or terminals 140 and 142.

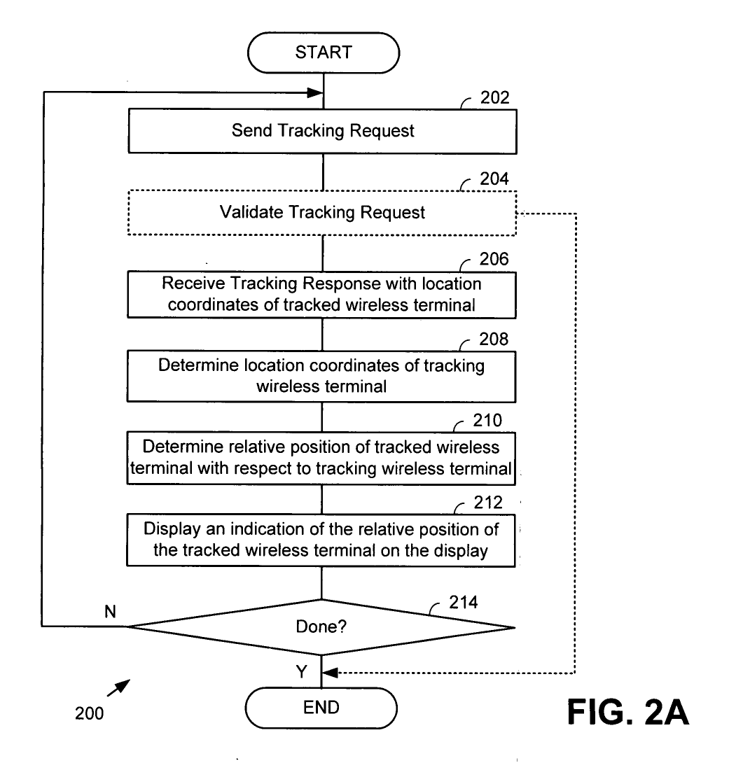

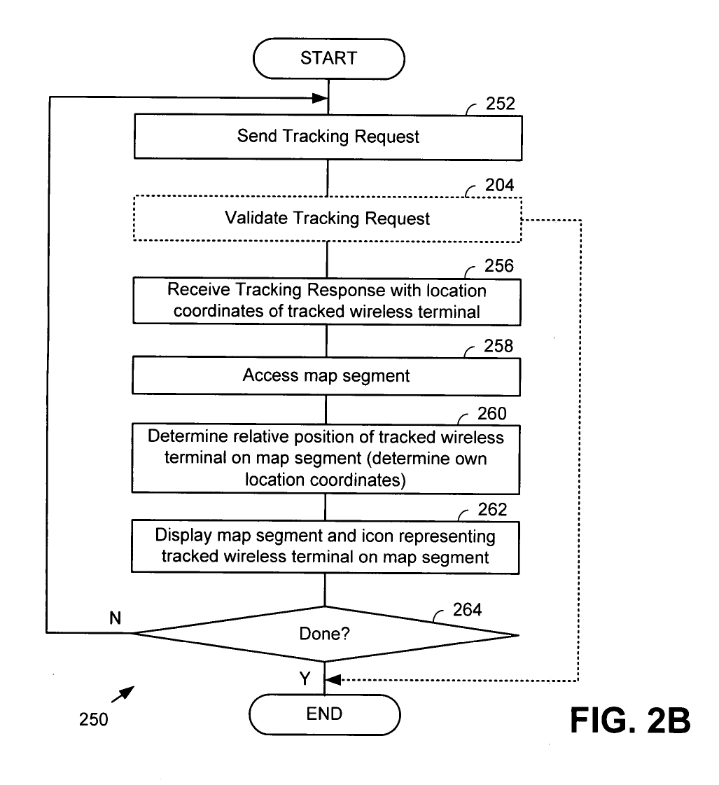

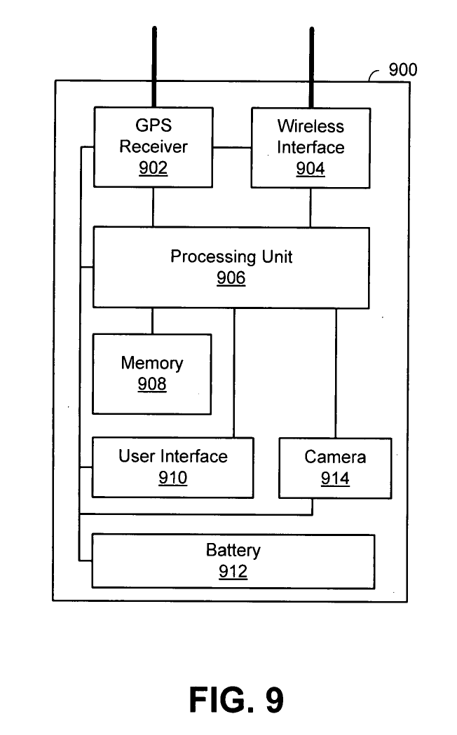

The operation of the wireless communication system 100 and of the wireless terminals 118-132 supported thereby will be described further with reference to FIGS. 2-9 and 10. The structure of the wireless terminals 118-132 will be described further with reference to FIG. 9. Generally, a tracking wireless terminal, e.g., 118, is operable to track a tracked wireless terminal, e.g., 128, and display tracking information to a user of the tracking wireless terminal. Operation commences with the tracking wireless terminal 118 sending a tracking request for the tracked wireless terminal via a supporting wireless network infrastructure 134. When the tracking request is valid, the tracking wireless terminal 118 receives a tracking response for the tracked wireless terminal via the supporting wireless network infrastructure 134. The tracking response includes location coordinates corresponding to the tracked wireless terminal 128. Based upon the tracking response, the tracking wireless terminal 118 accesses a map segment corresponding to the location coordinates. This map segment may be stored locally within the tracking wireless terminal 118 or may be accessed via the supporting wireless network infrastructure from a server, e.g., 140.

Operation continues with the tracking wireless terminal 118 determining a relative position of the location coordinates of the tracked wireless terminal 128 with respect to the map segment. With this determination made, operation concludes with the tracking wireless terminal 118 displaying the map segment and an icon on the map segment that represents the tracked wireless terminal 128. The icon representing the tracked wireless terminal 128 is displayed at the relative position of the location coordinates of the tracked wireless terminal 128.

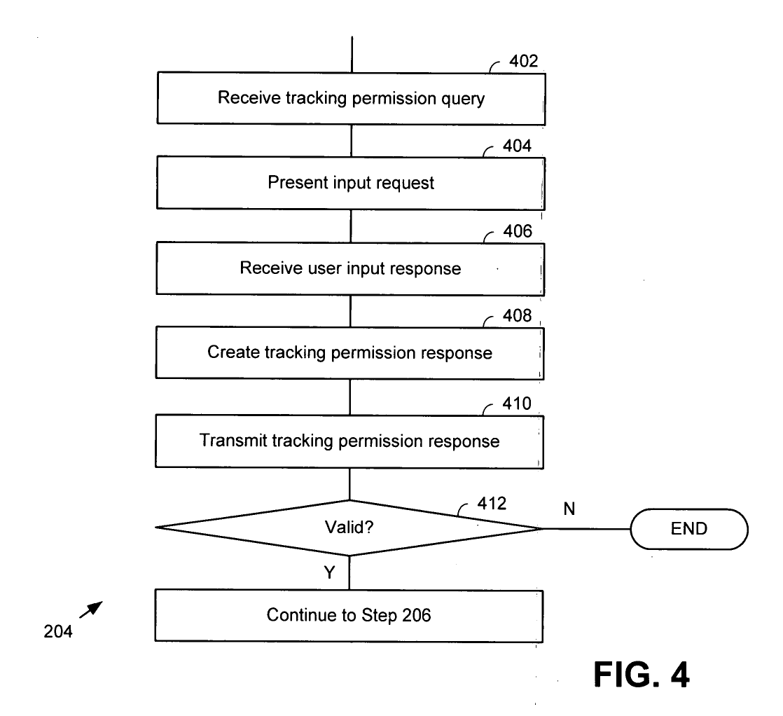

FIG. 2A is a flow chart illustrating a first embodiment of operation 200 according to the present invention. The operation 200 of FIG. 2A commences with a tracking wireless terminal sending a tracking request for a tracked wireless terminal via a supporting wireless network infrastructure and its wireless interface (Step 202). Operation continues with the tracking request being optionally validated (Step 204). Details of one embodiment of the operation at Step 204 are illustrated further in FIG. 4 and will be described with reference thereto.

Operation continues with the tracking wireless terminal receiving a tracking response via the supporting wireless network infrastructure (Step 206). The tracking response includes location coordinates corresponding to the tracked wireless terminal. The tracking wireless terminal then determines its own location coordinates by accessing an on-board Global Positioning System (GPS) receiver, for example (Step 208). Alternately, the tracking wireless terminal may determine its own location coordinates by sending a location request to the supporting wireless network infrastructure. The supporting wireless network infrastructure determines the location of the tracking wireless terminal and the servicing network then responds to the tracking wireless terminal with a location response that includes the location coordinates of the tracking wireless terminal.

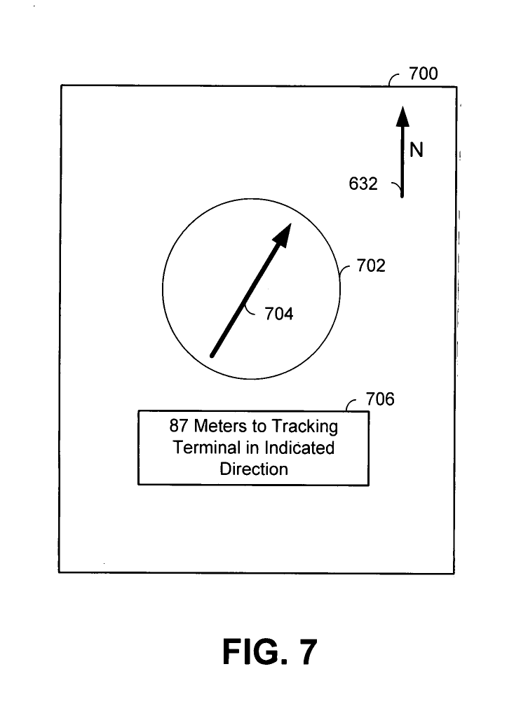

The tracking wireless terminal next determines a relative position of the location coordinates of the tracked wireless terminal with respect to its own location coordinates (Step 210). The tracking wireless terminal then displays an indication of the relative position of the tracked wireless terminal on its display (Step 212). One technique for displaying such indication is described herein subsequently with reference to FIG. 7. Operation continues from Step 212 to Step 214 where it is determined whether operation for the particular tracking is completed. If operation is not completed, operation returns to Step 202. However, if operation is completed operation ends.

FIG. 2B is a flow chart illustrating a second embodiment of operation 250 according to the present invention. The operation 250 of FIG. 2B commences with a tracking wireless terminal sending a tracking request for a tracked wireless terminal via a supporting wireless network infrastructure and its wireless interface (Step 252). Operation continues with the tracking request being validated (Step 204). Details of one embodiment of the operation at Step 204 are illustrated further in FIG. 4 and will be described with reference thereto.

Operation continues with the tracking wireless terminal receiving a tracking response via the supporting wireless network infrastructure (Step 256). The tracking response includes location coordinates corresponding to the tracked wireless terminal. Based upon the tracking response, the tracking wireless terminal accesses a map segment corresponding to the location coordinates (Step 258). The map segment may be stored locally to the wireless terminal. Alternatively, the map segment may be accessed by the tracking wireless terminal via the network infrastructure to a server computer that stores the map segment(s). When the tracking wireless terminal is contained in/located within an automobile, for example, the automobile may include a CD or DVD drive that stores many different map segments. In this case, the tracking wireless terminal simply accesses the CD or DVD drive to obtain the particular map segment. When the tracking wireless terminal is a handheld terminal, for example, the tracking wireless terminal will have limited onboard storage and will access the map segment via the supporting wireless network infrastructure.

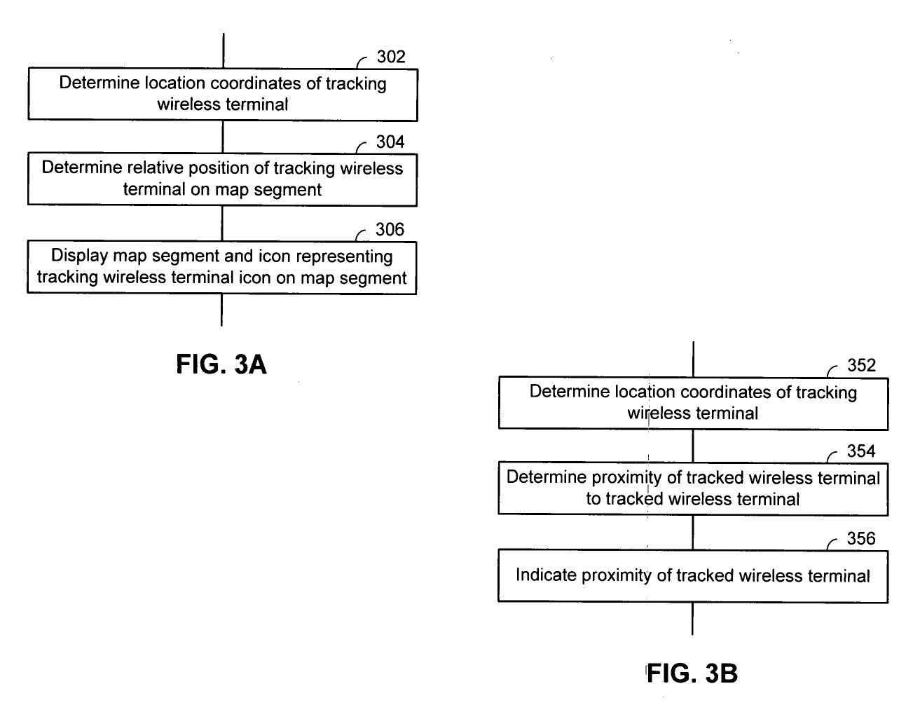

Operation continues with the tracking wireless terminal determining a relative position of the location coordinates of the tracked wireless terminal with respect to the map segment (Step 260). The operations of Step 260 may include determining the location coordinates of the tracking wireless terminal as will be described further with reference to FIGS. 3A and 3B. The tracking wireless terminal then displays the map segment and an icon that represents the tracked wireless terminal on the map segment at the relative position of the location coordinates of the tracked wireless terminal (Step 262). Operation continues from Step 262 to Step 264 where it is determined whether operation for the particular tracking is completed. If operation is not completed, operation returns to Step 252. However, if operation is completed operation ends.

FIG. 3A is a partial flow chart illustrating a first optional aspect of the present invention that may be used in conjunction with the operations of FIG. 2B. As shown in FIG. 3A, the tracking wireless terminal may determine its location coordinates by accessing an on-board Global Positioning System (GPS) receiver or by accessing the supporting wireless network infrastructure (Step 302). The tracking wireless terminal then determines a relative position of the location coordinates of the tracking wireless terminal on the map segment (Step 304). The tracking wireless terminal then displays the map segment and an icon representing the tracking wireless terminal on the map at the relative position of the location coordinates of the tracking wireless terminal (Step 306). Operations of Steps 302-306 may be performed after Step 262 of FIG. 2B or in conjunction with Steps 260 and 262 of FIG. 2B. In either case, the tracking wireless terminal will display the map segment with icons representing both the tracked wireless terminal and the tracking wireless terminal.

FIG. 3B is a partial flow chart illustrating an optional second aspect of the present invention that may be used with either/both of the operations of FIGS. 2A and 2B. As shown in FIG. 3B, operation commences with the tracking wireless terminal determining location coordinates of the tracking wireless terminal (Step 352). These location coordinates would typically be based upon an access of an onboard GPS receiver. Alternatively, the tracking wireless terminal may access the supporting wireless network infrastructure to determine its location coordinates. Then, the tracking wireless terminal determines its proximity to the tracked wireless terminal (Step 354). Operation concludes with indicating a proximity of the tracked wireless terminal to the tracking wireless terminal (Step 356). The operations of Steps 352-356 may be performed after Step 212 of FIG. 2A or in conjunction with the operations of Steps 210 and 212 of FIG. 2A. The operations of Steps 352-356 may also be performed after Step 262 of FIG. 2B or in conjunction with the operations of Steps 260 and 262 of FIG. 2B.

In indicating the proximity of the tracked wireless terminal at Step 356, the tracking wireless terminal may compare the proximity to a proximity threshold and issue a proximity alert based upon a favorable comparison. Likewise, the tracking wireless terminal may compare the proximity to a plurality of proximity thresholds and issue a proximity alert of a plurality of proximity alerts based upon a corresponding favorable comparison. Proximity alerts may include, for example, flashing light that has a flashing pattern corresponding to the proximity alert, an audible alarm that has an audible pattern corresponding to the proximity alert, a visual meter reading having an indicated magnitude corresponding to the proximity alert, and a visual vector reading having an indicated magnitude and direction corresponding to the proximity alert.

Thus, the operations of FIG. 3B are intended to provide the user of information regarding the relative position/proximity of the tracking wireless terminal to the tracked wireless terminal. Thus, when a user of one wireless terminal is desirous of meeting the user of another wireless terminal, the users of the wireless terminals may implement these features to provide them assistance in finding one another. Such assistance would be significantly useful in a setting in which many persons are present, for example a concert, a picnic, a ball game, or another event in which a large number of people are present but in which geographic features are substantially missing. Such operation is particularly useful, for example, when a parent has lost a child, and the child is wearing a reduced functionality wireless terminal that operates according to the present invention. In such case, the parent could initiate the tracking operations of the present invention to immediately locate the lost child using the operations of FIGS. 2A, 2B, and/or 3B. Law enforcement personnel could also employ the operations of the present invention to track down immediately stolen cars that support the operations of the present invention, criminals that are required to wear a security bracelet, or in other tracking operations.

FIG. 4 is a partial flow diagram illustrating a third optional aspect of the present invention. FIG. 4 illustrates in more detail the operations of Step 204 of FIG. 2A and Step 204 of FIG. 2B. Operation commences with the tracking wireless terminal receiving a tracking permission query from a requesting device via the supporting wireless network infrastructure (Step 402). The tracking wireless terminal then presents an input request in response to the tracking permission query via a user interface (Step 404). The tracking wireless terminal then receives a user input response via the user interface (Step 406) and creates a tracking permission response based upon the user and response (Step 408). The tracking wireless terminal then transmits the tracking permission response via the supporting wireless network infrastructure to the requesting device (Step 410). When the tracking permission response is not valid (as determined at Step 412) operation ends. Such ending of operation directly relates to the end of operation shown in FIGS. 2A and 2B. However, when the tracking permission response is valid, operation from Step 412 continues to Step 206 of FIG. 2A (or to step 256 of FIG. 2B).

The requesting device may be the tracked wireless terminal. Alternatively, the requesting device may be a monitoring location terminal that serves as a gate keeper for tracking operations, a partnered wireless terminal that acts as an intervening party in determining whether the tracking wireless terminal should be able to track the tracked wireless terminal, or a partnered landline terminal that has similar functionality.

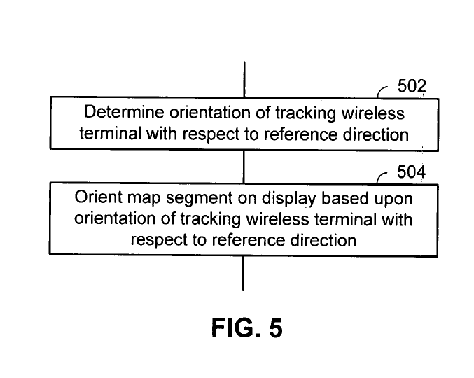

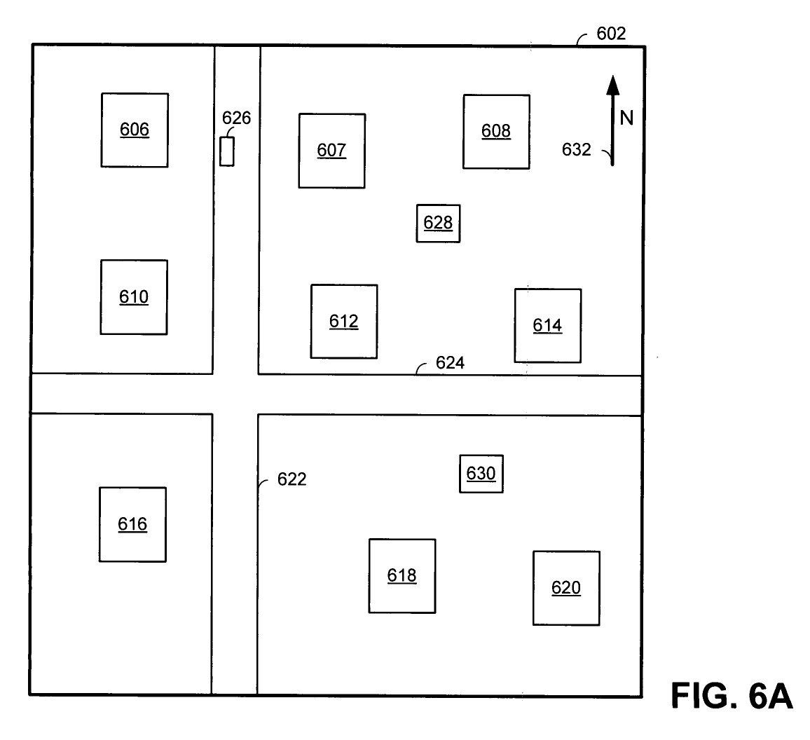

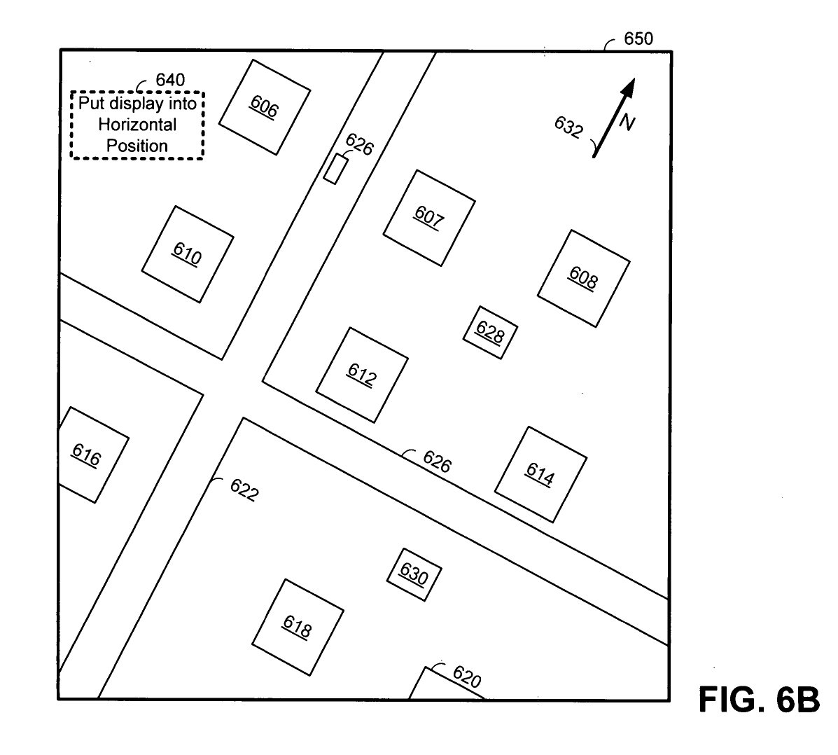

FIG. 5 is a partial flow diagram illustrating a fifth optional aspect of the present invention. The operations of FIG. 5 may be referred to as “compass mode” operations. With the compass mode operations, the tracking wireless terminal determines an orientation of the tracking wireless terminal with respect to a reference direction (Step 502). This reference direction may be magnetic north, actual north, or another reference direction. Typically, this reference direction is determined based upon a magnetic compass, access of the GPS receiver, or by another mechanism supported by the tracking wireless terminal. Based upon the determined orientation, the tracking wireless terminal orients the map segment on the display based upon the orientation of the tracking wireless terminal so that the map segment is displayed in a correct orientation with reference to mapped physical features (Step 504). The operation of Steps 502 and 504 may be performed concurrently with Steps 210 and 212 of FIG. 2A or simply in concurrence with Step 212 of FIG. 2A. FIGS. 6A and 6B illustrate further the teachings of the compass mode feature of FIG. 5.

FIG. 6A is a block diagram representing a display of a wireless terminal operating according to the present invention. As shown in FIG. 6A, the display 602 of the tracking wireless terminal has displayed there upon a map segment along with icons that represent a tracking wireless terminal 626 and tracked wireless terminals 628 and 630. The display 602 is consistent with the operations of FIG. 2B. Shown in the map segment are geographic entities 606, 607, 608, 610, 612, 614, 616, 618, and 620 (referred to hereinafter as 606-620). These geographic entities 606-620 may be buildings, parks, landmarks, parking areas, or other geographic features identified within the map segment. The tracking wireless terminal may identify or provide additional information with regard to these geographic features 606-620. The actual size and shape of these geographic features 606-620 may be indicated in more detail than is shown in FIG. 6A.

The map segment shown on display 602 also shows roads 622 and 624. The tracking wireless terminal 626 is shown as an icon in the shape of an automobile because it is residing upon road 622. Track wireless terminal 628 and 630 are shown as different icons because they are not currently present on an identified roadway of the map segment. Thus, as is shown in FIG. 6A, the relative position and proximity of the tracked wireless terminal 628 and 630 with respect to tracking wireless terminal 626 are clearly shown. This information may be employed by the user of tracking wireless terminal 626 to not only identify the current location of tracked wireless terminals 628 and 630 but to physically meet the users of these tracked wireless terminals 628 and 630 using the map segment displayed on display 602. The map segment is shown in one orientation with a reference direction 632 which in the example of FIG. 6A is the direction north.

FIG. 6B is a block diagram representing a display of a wireless terminal operating according to the present invention and when in a compass mode. As shown in FIG. 6B, the map segment on display 650 has been oriented based upon the orientation of the tracking wireless terminal with respect to a reference direction so that the geographic features 606-620 of the map segment are displayed in a correct orientation with reference to the orientation of the wireless terminal. As is shown, the north vector 632 is not oriented vertically on the display 650. Thus, as compared to the display 602 of FIG. 6A, the tracking wireless terminal resides in a different physical orientation with respect to the reference direction 632. The teachings illustrated in FIGS. 6A and 6B may be easily extended to any particular orientation of the tracking wireless terminal. Based upon the particular orientation of the wireless terminal, the reference numerals and information relating to the geographical features may be oriented in different directions for easier access by the user of the tracking wireless terminal.

Note that the operations of FIG. 6B work best when a plane of the display orients substantially in parallel to the surface of the earth. In this orientation, a reference direction of the wireless terminal, e.g., a side of the display 650, may most easily be compared to the reference direction 632. Thus, the display 602 may include a warning 640 directing the user to place the display into a horizontal position. With the display 602 in the horizontal position the geographic features 606-620 of the map segment may be most easily displayed in a correct orientation with reference to the orientation of the wireless terminal. With the display 602 not in a horizontal position, two separate operations may be employed. The relative orientation of the wireless terminal with respect to the reference direction may be best estimated and the display 602 updated based upon the best estimate. Alternately, the wireless terminal may use a last valid estimate of the relative orientation of the wireless terminal with respect to the reference direction.

FIG. 7 is a block diagram representing a display operating according to another embodiment of the present invention. The display 700 is consistent with the operations of FIG. 2A. The display includes an indication of the relative position of the tracked wireless terminal with respect to the tracking wireless terminal. With the particular embodiment illustrated in FIG. 7, a vector 704 contained within a boundary 602 and a distance indication 706 provides the indication. A reference direction 632, e.g., North, may also be provided to the user for additional information. With this information, that is continually updated, a user of the wireless terminal may easily determine the relative position of the tracked wireless terminal.

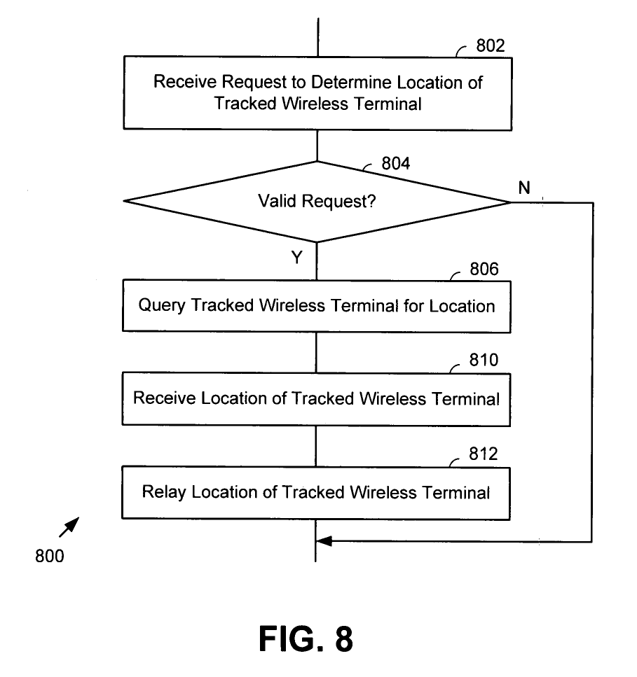

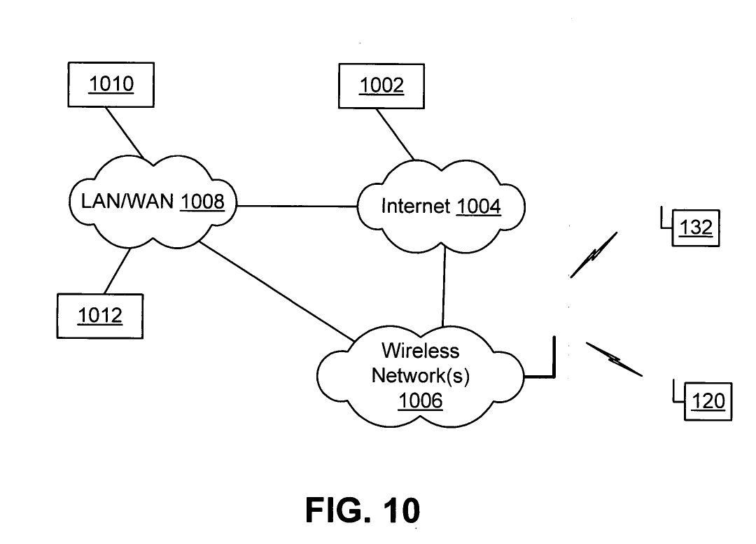

FIG. 8 is a flow diagram illustrating operation according to the present invention in servicing a tracking request. The operation 800 at FIG. 8 commences in receiving a request from a tracking wireless terminal to determine location coordinates of a tracked wireless terminal (step 802). When the user of the tracked wireless terminal is a child, a parent, or simply a user for which the location is of interest, the servicing device would first determine if the request is valid (step 804). Validation of the request may require a password entry by the requesting tracking wireless terminal, or such other validation mechanism that would be appropriate in the given operation. If the request is valid as in step 804, the servicing device, via the supporting wireless network infrastructure, queries the tracked wireless terminal for its location (step 806). In response, the tracked wireless terminal would determine its location coordinates and transmit them to the requesting device either directly or indirectly. The location coordinates of the tracked wireless terminal are then received (step 810) and relayed to the tracking wireless terminal (step 812). The device or devices performing the operations of FIG. 8 may be one or more of the devices 1002, 1010, and/or 1012 illustrated in FIG. 10.

Because of privacy concerns, it may be the case that authority to determine the location of a minor would have to be established prior to request by the requesting device. Alternately, law enforcement agencies, parole agents, or other governmental entities may have blanket authority to determine location of wireless terminal coupled or used by particular users of the wireless terminal. For example, a criminal on parole may have coupled thereto a wireless terminal that is a condition of the parole itself. In such case, the location of the parolee would be trackable because of the constant possession of the tracked wireless terminal. Another example, a relative may give authority to his other relatives to track his or her location via the wireless terminal. In this case, the individuals tracking the location of the tracked wireless terminal will feel secure in the knowledge that the user is in a safe location.

FIG. 9 is a block diagram illustrating a wireless terminal constructed according to the present invention. As shown in FIG. 9, the wireless terminal 900 includes a GPS receiver 902, a wireless interface 904, a processing unit 906, memory 908, user interface 910, and a battery 912. The components of the wireless terminal 900 are typically contained within a hard case that provides protection from the elements. The wireless interface 904 will have particular structure and functionality based upon the type of the wireless terminal 900. For example, when the wireless terminal 900 is a cellular telephone, the wireless interface 904 will support a corresponding interface standard e.g., GSM, GPRS, EDGE, UMTS, 1xRTT, 1xEV-DO, 1xEV-DV, etc. The wireless interface 904 of the cellular telephone 904 may also/alternately support WWAN, WLAN and/or WPAN functionality. When the wireless terminal is a WLAN terminal for example, the wireless interface 904 will support standardized communication according to the IEEE 802.11x group of standards, for example. When the wireless terminal is a WPAN device, the wireless interface 904 would support the Bluetooth interface standard or another WPAN standard such as the 802.15 standard. In any case, the wireless interface 904 may support all or a subset of cellular telephone, WLAN, and WPAN operations.

The processing unit 906 may include any type of processor such as a microprocessor, a digital signal processor, an Application Specific Integrated Circuit (ASIC), or a combination of processing type devices. The processing unit 906 is operable to execute a plurality of software instructions that are stored in memory 908 and downloaded for execution. The processing unit 906 may also include specialized hardware required to implement particular aspects of the present invention. Memory 908 may include SRAM, DRAM, PROM, flash RAM, or any other type of memory capable of storing data and instructions.

A user interface 910 may include a microphone, a speaker, a keypad, a screen, a touch screen, a light, a voice recognition system, an optical recognition system that would authenticate a user's iris, for example, and/or any other type of interface that may be employed in the wireless terminal. In some embodiments, the user interface 910 may include therewith ability to service a headset including microphone and earpiece for the user. In some embodiments of the wireless terminal 900, the user interface 910 is of reduced functionality to minimize the size of the wireless terminal 900. In such case, programming of the wireless terminal 900 may be performed via the wireless interface 904. In such case, the wireless terminal 900 may be small enough to be worn around a child's wrist, around the neck, pinned to the inside of clothing, placed in a pocket, or concealed upon the person. Battery 912 powers the components of the wireless terminal 900.

FIG. 10 is a system diagram illustrating a system that may be used according to the present invention. The system includes a wireless network 1006 that supports wireless communications with the wireless terminal 120, the Internet 1002, and a LAN/WAN 1008 that intercouples with the Internet 1004 and the wireless network 1006.

The system of FIG. 10 may be employed to service the tracking operations of the present invention. In such case, wireless terminal 120 may be desired to track wireless terminal 132. In such case, wireless terminal 120 accesses wireless network 1006 requesting to track wireless terminal 132. Server computer 1010 or 1002 may validate the tracking request from the tracking wireless terminal 120. In such case, the server computer 1010 or 1002 may validate or invalidate the tracking request. User terminal 1012 may be employed to create groups of tracking wireless terminals that have permission to track particular tracked wireless terminals. Alternatively, user terminal 1012 may be employed on a real time basis to either grant or deny the tracking request.

As one of average skill in the art will appreciate, the term “substantially” or “approximately,” as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the terms “communicatively coupled” or “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and description thereto are not intended to limit the invention to the particular form disclosed, but on the contrary, the invention is to cover all modifications, equivalents, and alternatives falling within the spirit and scope of the present invention as defined by the claims.

1. A method for operating a tracking wireless terminal to display a location of a tracked wireless terminal, the method comprising:
sending a tracking request for the tracked wireless terminal via a supporting wireless network infrastructure;
receiving a tracking response for the tracked wireless terminal via the supporting wireless network infrastructure that includes location coordinates of the tracked wireless terminal;
determining location coordinates of the tracking wireless terminal;
determining a relative position of the location coordinates of the tracked wireless terminal with respect to the location coordinates of the tracking wireless terminal; and
displaying an indication on the display to indicate the relative position of the tracked wireless terminal with respect to the tracking wireless terminal.

2. The method of claim 1, further comprising:
accessing a map segment corresponding to the location coordinates;
determining a relative position of the location coordinates of the tracked wireless terminal with respect to the map segment; and
displaying the map segment and an icon that represents the tracked wireless terminal on the map segment at the relative position of the location coordinates of the tracked wireless terminal.

3. The method of claim 2, further comprising:
determining a relative position of the location coordinates of the tracking wireless terminal on the map segment; and
displaying an icon that represents the tracking wireless terminal on the map at the relative position of the location coordinates of the tracking wireless terminal.

4. The method of claim 1, further comprising:
receiving a tracking permission query from a requesting device via the supporting wireless network infrastructure;
presenting an input request in response to the tracking permission query via a user interface;
receiving a user input response via the user interface;
creating a tracking permission response based upon the user input response; and
transmitting the tracking permission response via the supporting wireless network infrastructure to the requesting device.

5. The method of claim 4, wherein the requesting device is selected from the group consisting of at least the tracked wireless terminal, a monitoring location terminal, a partnered wireless terminal, and a partnered land line terminal.

6. The method of claim 1, wherein the tracking request includes an identity of the tracking wireless terminal.

7. The method of claim 6, wherein the tracking wireless terminal is a member of a group having permission to track the tracked wireless terminal.

8. The method of claim 1, further comprising:
determining a proximity of the tracking wireless terminal to the tracked wireless terminal;
comparing the proximity to a proximity threshold; and
issuing a proximity alert upon a favorable comparison.

9. The method of claim 1, further comprising:
determining a proximity of the tracking wireless terminal to the tracked wireless terminal;
comparing the proximity to a plurality of proximity thresholds; and
issuing a proximity alert of a plurality of proximity alerts based upon a corresponding favorable comparison.

10. The method of claim 8, wherein the proximity alert is selected from the group consisting of at least:
a flashing light having a flashing pattern corresponding to the proximity alert;
an audible alarm having an audible pattern corresponding to the proximity alert;
a visual meter reading having an indicated magnitude corresponding to the proximity alert; and
a visual vector reading having an indicated magnitude and direction corresponding to the proximity alert.

11. The method of claim 2, further comprising:
determining an orientation of the tracking wireless terminal with respect to a reference direction; and
orienting the map segment on the display based upon the orientation of the tracking wireless terminal so that the map segment is displayed in a correct orientation with reference to mapped physical features.

12. A wireless terminal comprising:
a wireless interface;
a user interface including a display;
a Global Positioning System (GPS) receiver; and
a processing unit communicatively coupled to the wireless interface, the user interface, and the GPS receiver and operable to:
send a tracking request for a tracked wireless terminal via the wireless interface and a supporting wireless network infrastructure;
receive a tracking response for the tracked wireless terminal via the wireless interface and the supporting wireless network infrastructure that includes location coordinates corresponding to the tracked wireless terminal;
determine location coordinates of the tracking wireless terminal by accessing the GPS receiver;
determine a relative position of the location coordinates of the tracked wireless terminal with respect to the location coordinates of the tracking wireless terminal; and
display an indication on the display to indicate the relative position of the tracked wireless terminal with respect to the tracking wireless terminal.

13. The wireless terminal of claim 12, wherein the processing unit is further operable to:
access a map segment corresponding to the location coordinates;
determine a relative position of the location coordinates of the tracked wireless terminal with respect to the map segment; and
display the map segment and an icon that represents the tracked wireless terminal on the map segment at the relative position of the location coordinates of the tracked wireless terminal on the display.

14. The wireless terminal of claim 13, wherein the processing unit is further operable to:
determine a relative position of the location coordinates of the tracking wireless terminal on the map segment; and
display an icon that represents the tracking wireless terminal on the map at the relative position of the location coordinates of the tracking wireless terminal on the display.

15 The wireless terminal of claim 12, wherein the processing unit is further operable to:
receive a tracking permission query from a requesting device via the supporting wireless network infrastructure and the wireless interface;
present an input request in response to the tracking permission query via the user interface;
receive a user input response via the user interface;
create a tracking permission response based upon the user input response; and
transmit the tracking permission response via the wireless interface and the supporting wireless network infrastructure to the requesting device.

16 The wireless terminal of claim 15 wherein the requesting device is selected from the group consisting of at least the tracked wireless terminal, a monitoring location terminal, a partnered wireless terminal, and a partnered land line terminal.

17 The wireless terminal of claim 12, wherein the tracking request includes an identity of the wireless terminal.

18 The wireless terminal of claim 17 wherein the wireless terminal is a member of a group having permission to track the tracked wireless terminal.

19 The wireless terminal of claim 12, wherein the processing unit is further operable to:
determine a proximity of the wireless terminal to the tracked wireless terminal;
compare the proximity to a proximity threshold; and
issue a proximity alert upon a favorable comparison via the user interface.

20. The wireless terminal of claim 12, wherein the processing unit is further operable to:
determine a proximity of the wireless terminal to the tracked wireless terminal;
compare the proximity to a plurality of proximity thresholds; and
issue a proximity alert of a plurality of proximity alerts based upon a corresponding favorable comparison via the user interface.

21. The wireless terminal of claim 20, wherein the proximity alert is selected from the group consisting of at least:
a flashing light having a flashing pattern corresponding to the proximity alert;
an audible alarm having an audible pattern corresponding to the proximity alert;
a visual meter reading having an indicated magnitude corresponding to the proximity alert;
a visual vector reading having an indicated magnitude and direction corresponding to the proximity alert.

22. The wireless terminal of claim 12, further comprising:
determining an orientation of the tracking wireless terminal with respect to a reference direction; and
orienting the map segment on the display based upon the orientation of the tracking wireless terminal so that the map segment is displayed in a correct orientation with reference to mapped physical features.
